(19) United States
(12) Patent Application Publication
(10) Pub. No.: US 2026/0109241 A1
(43) Pub. Date: Apr. 23, 2026

(54) POWER CORD PLUG HAVING BREAKAWAY AND CONDUCTOR ISOLATION FEATURE

(71) Applicant: Textron Inc., Providence, RI (US)

(72) Inventors: Dylan James Arnold, Martinez, GA (US); Russell William King, Evans, GA (US); David Alan Smith, JR., Graniteville, SC (US)

(73) Assignee: Textron Inc., Providence, RI (US)

(21) Appl. No.: 18/924,502

(22) Filed: Oct. 23, 2024

(51) Int. Cl. B60L 53/16; B60L 53/18; H01R 13/502; H02G 15/007; H02G 15/18

(52) U.S. Cl. CPC B60L 53/16; B60L 53/18; H01R 13/502; H02G 15/007; H02G 15/18; H01R 2201/26

(57) ABSTRACT

A power cord assembly includes a charging plug. The charging plug includes a housing having a plug end configured to interface with a charging port of an electric vehicle and a cord end; and a charging interface position at the plug end of the housing. The power cord assembly includes a power cord extending through the cord end of the housing and coupled to the charging interface. The power cord includes wires, the wires including a conductor having a breakaway joint along a length between a first portion and a second portion of the conductor. The power cord assembly includes one or more insulators disposed along the length of the conductor. Upon failure of the conductor at the breakaway joint, the insulators are configured to separate such that a free end of the first portion of the conductor is covered.

### BACKGROUND

With the increased adoption of electrified vehicles, increased occurrences of electric shocks are occurring as a result of damaged power cables. Specifically, power cables have been susceptible to being ripped out of charging plugs connected to charging ports of electric vehicles. Such events can lead to live wires being open to the environment, leading to electrical shocks can occur when a person or object comes into contact with the live wires.

### SUMMARY

One embodiment relates to a power cord assembly. The power cord assembly includes a charging plug and a power cord. The charging plug includes a housing having a plug end configured to interface with a charging port of an electric vehicle and a cord end; and a charging interface position at the plug end of the housing. The power cord is configured to extend through the cord end of the housing and coupled to the charging interface. The power cord includes a plurality of wires, each of the plurality of wires including a conductor having a breakaway joint along a length thereof between a first portion of the conductor and a second portion of the conductor. The first portion is configured to be connected to a power source and the second portion is configured to be connected to the charging interface. The power cord assembly includes one or more insulators disposed along the length of the conductor. Upon failure of the conductor at the breakaway joint, the one or more insulators are configured to separate such that a free end of the first portion of the conductor is covered.

Another embodiment relates to a power cord assembly. The power cord assembly includes a power cord configured to extend into a charging plug and couple to a charging interface thereof. The power cord includes a plurality of wires, each of the plurality of wires including a conductor having a breakaway joint along a length thereof between a first portion of the conductor and a second portion of the conductor. The first portion is configured to connect to a power source and the second portion is configured to connect to the charging interface. The power cord includes one or more insulators disposed along the length of the conductor. Upon failure of the conductor at the breakaway joint, the one or more insulators are configured to separate such that a free end of the first portion of the conductor is covered.

Still another embodiment relates to a power cord assembly. The power cord assembly includes a charging plug and a power cord. The charging plug includes a housing having a plug end configured to interface with a charging port of an electric vehicle and a cord end. The charging plug includes a charging interface position at the plug end of the housing. The power cord extends through the cord end of the housing and coupled to the charging interface. The power cord includes a plurality of wires. Each of the plurality of wires including a conductor having a breakaway joint along a length thereof between a first portion of the conductor and a second portion of the conductor. The first portion is configured to be connected to a power source and the second portion is configured to be connected to the charging interface. The wires include a first insulator disposed along a portion of the first portion. The wires include a second insulator disposed along a portion of the second portion such that a gap is present between the first insulator and the second insulator. The wires include a third insulator extending between the first insulator and the second insulator across the gap and around the breakaway joint. Upon failure of the conductor at the breakaway joint, the first insulator and the third insulator are configured to separate from the second insulator such that a free end of the first portion of the conductor is covered.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a perspective view of a charging system for the vehicle of FIG. 1 including a charging plug, a charger, and a power cable connecting the charging plug with the charger, according to an exemplary embodiment.

FIG. 5 is a detailed view of a wire conductor of the power cable of FIG. 4 with a conductor isolation feature in a first configuration, according to an exemplary embodiment.

FIG. 6 is another detailed view of the wire conductor of FIG. 5 with the conductor isolation feature in a second configuration, according to an exemplary embodiment.

FIG. 7 is another view of the charging plug and the power cable of FIG. 4 in a separate state, according to an exemplary embodiment.

FIG. 8 is a detailed view of the charging plug and the power cable of FIG. 4 where the charging plug has a conductor isolation feature, according to another exemplary embodiment.

FIG. 9 is a detailed view of the conductor isolation feature of FIG. 8, according to an exemplary embodiment.

FIG. 10 is another view of the charging plug and the power cable of FIG. 8 in a separate state, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

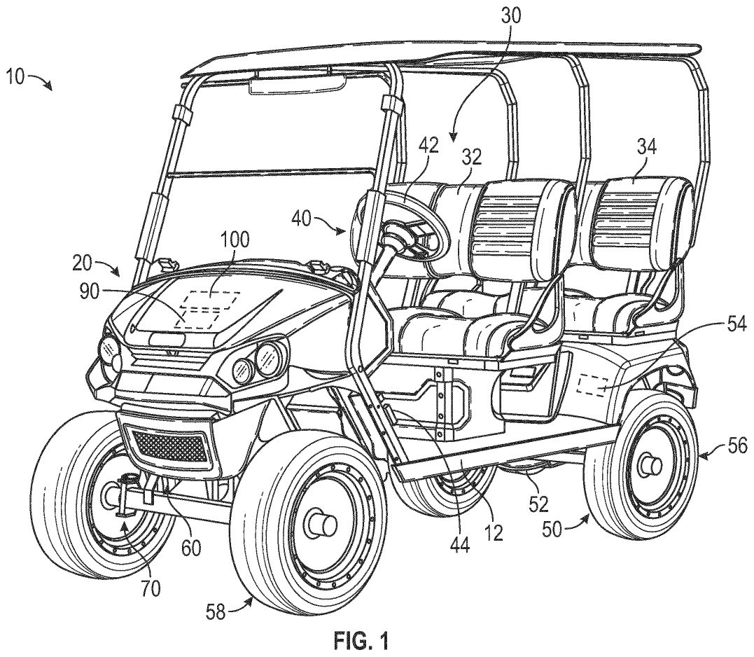

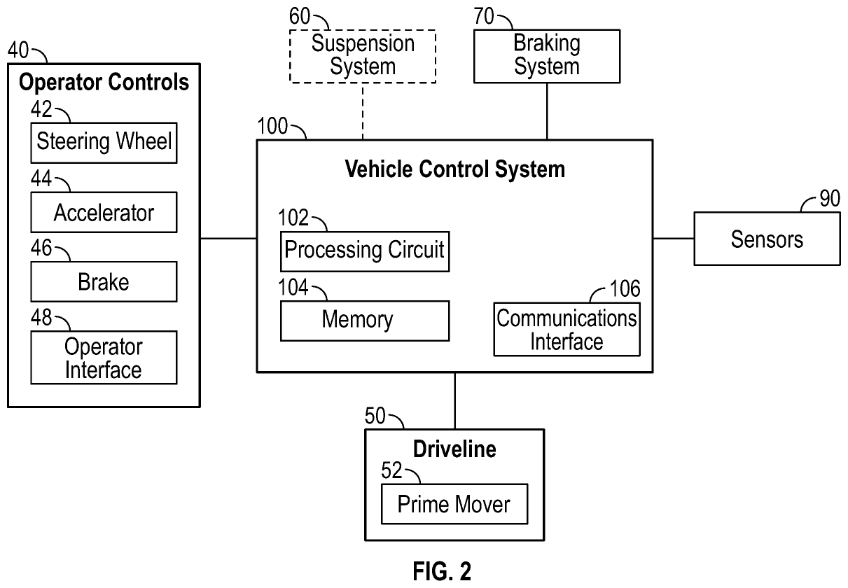

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

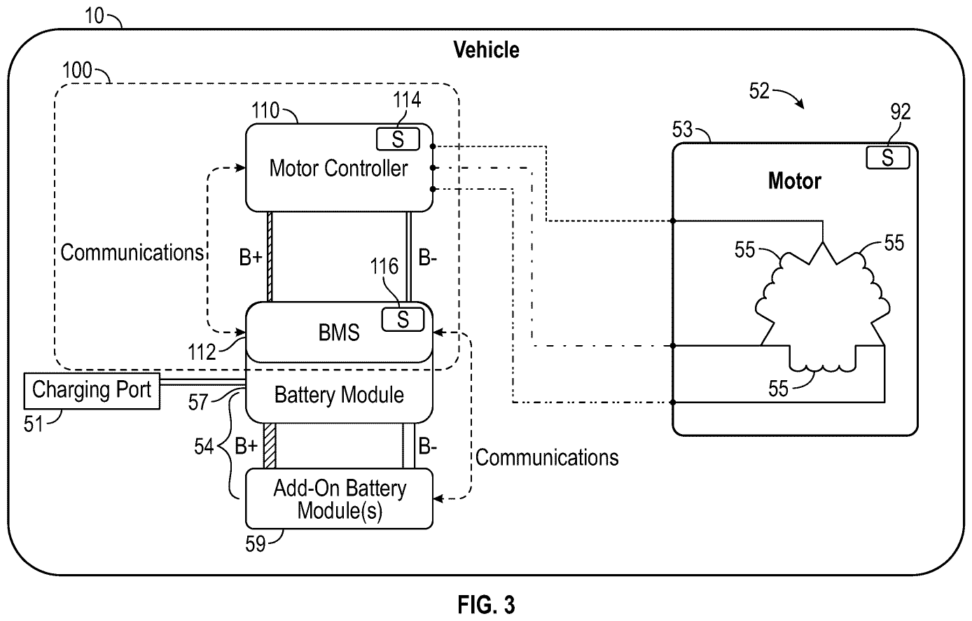

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

As shown in FIG. 3, the vehicle 10 includes an electrical port, shown as charging port 51, electrically connected to the energy storage 54. The charging port 51 is configured to facilities connecting the energy storage 54 to an electric charger to charge the energy storage 54 with power from an external power source. In some embodiments, the BMS 112 is configured to monitor the charging process based on power received via the charging port 51, ensuring proper and efficient energy transfer to the energy storage 54. In some embodiments, the charging port 51 is configured as an AC power port. In some embodiments, the charging port 51 is configured as a DC power port. In some embodiments, the charging port 51 is configured to accommodate both AC power and DC power.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

### Conductor Isolation Features

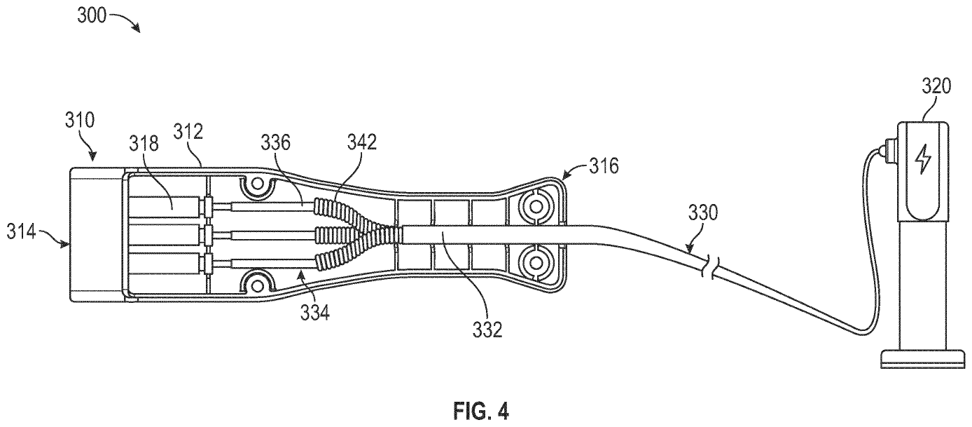

As shown in FIG. 4, a charger system, shown as battery charger system 300, is configured to engage with the charging port 51 to charge the energy storage 54. The battery charger system 300 includes a plug, shown as charging plug 310, a charger, shown as charging station 320, and a cable, shown as power cable 330, extending between and electrically connecting the charging plug 310 and the charging station 320. In some embodiments, the battery charger system 300 is configured as an AC charging system. In some embodiments, the battery charger system 300 is configured as a DC charging system.

In some embodiments, the battery charger system 300 is configured to provide AC charging or DC charging depending on whether the vehicle 10 includes an onboard charger (e.g., AC/DC conversion electronics). For example, in the case of onboard” charger (e.g., between the charging port 51 and the battery module 57), the charging station 320 is configured to provide AC power to the vehicle 10, where the onboard charger will convert the AC power to DC power for charging the energy storage 54. In another example, the power conversion is offboard and performed at the battery charger system 300 such that DC power is provided to the charging port 51 for storage by the energy storage 54.

As shown in FIG. 4, the charging plug 310 includes (a) a housing, shown as plug housing 312, having a first end, shown as plug end 314, configured to engage with the charging port 51 of the vehicle 10 and an opposing second end, shown as cable end 316, through which the power cable 330 extends through and (b) electrical interfaces, shown as charging interfaces 318, positioned at the plug end 314 of the plug housing 312, which are connected to the power cable 330. According to an exemplary embodiment, the plug housing 312 defines internal cavities and channels to accommodate a portion of the power cable 330. According to an exemplary embodiment, the charging interface 318 include or accommodate pins connectors.

As shown in FIG. 4, the power cable 330 includes an outer conduit or housing, shown as power cable casing 332, and one or more electrical wires, shown as wires 334, disposed within the power cable casing 332. Each of the wires 334 is coupled to one of the charging interfaces 318 of the charging plug 310 to facilitate providing power from the charging station 320 to the charging plug 310. According to the exemplary embodiment shown in FIG. 4, the power cable 330 includes three of the wires 334 (e.g., a live conductor which carries an electrical current, a neutral conductor which completes the electrical circuit and provides a return path for the electrical current, and a ground conductor which provides a path for electrical current to flow in the event of a fault or short circuit; one wire for each phase of three-phase AC power; etc.).

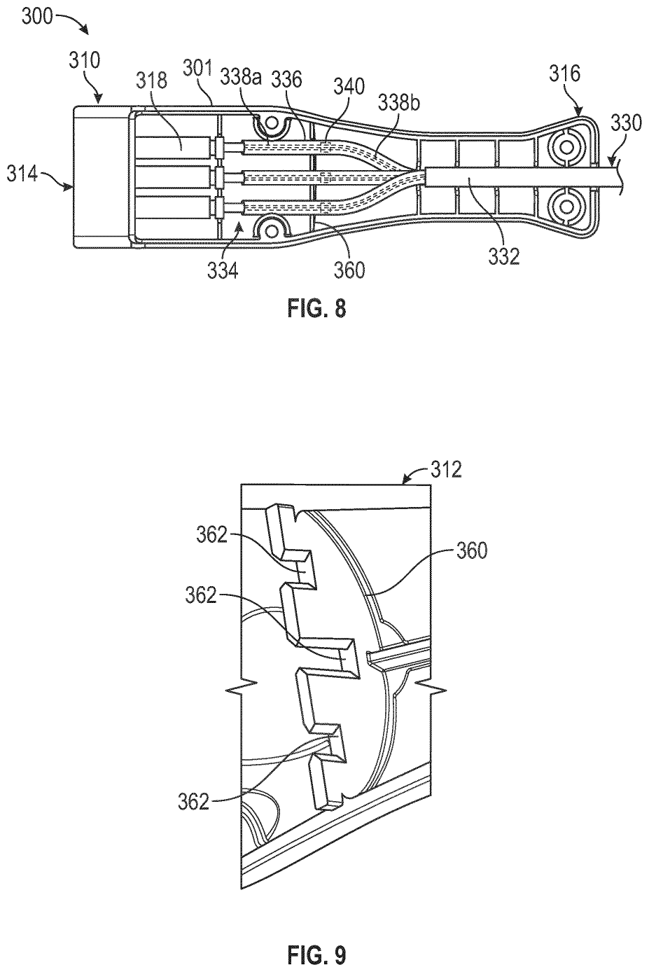

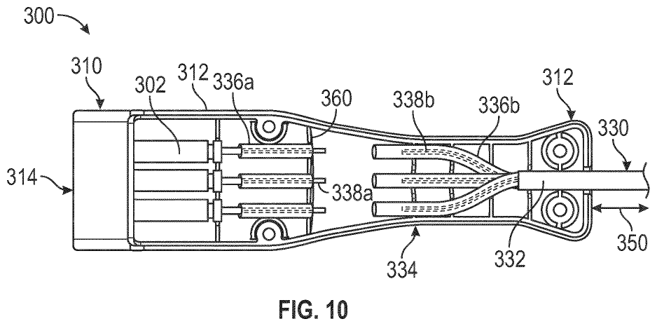

As shown FIG. 4-7, each of the wires 334 includes (a) a protective layer, insulator, or coating, shown as insulating casing 336, (b) a conductor, shown as wire conductor 338, disposed within the insulating casing 336, and (c) a conductor isolation feature, shown as insulators 342, positioned along the insulating casing 336 and around at least a portion of the wire conductor 338. In some embodiments (e.g., in FIGS. 8 and 10), the wires 334 do not include the insulators 342. In some embodiment (e.g., in FIGS. 8 and 10), the insulating casings 336 encapsulate the entire length of the wire conductors 338. In some embodiment (e.g., in FIG. 4-7), the insulating casings 336 do not encapsulate the entire length of the wire conductors 338. The insulating casings 336 may be color-coded (e.g., green, red, black, orange, etc.) to correspond with the wire conductors they insulate, aiding in identification and proper assembly. The insulating casings 302, 304, and 306 are configured to fit around the wire conductors 338 to minimize movement and prevent abrasion or damage thereto. The insulating casings 336 may be molded or formed into shapes to optimize space within the plug housing 312 The insulating casings 336 may be configured to dissipate heat generated during charging. The insulating casings 336 may be manufactured from thermoplastics, thermosets, elastomers, or a combination thereof. For example, the insulating casings 336 may be made from nylon, thermoplastic elastomer (“TPE”), polyurethane polycarbonate, epoxy resins, silicone rubber, or combinations of these materials. The insulating casings 336 may exhibit resistance to environmental factors such as ultraviolet (“UV”) radiation and moisture. The insulating casings 336 may be sheathings or wire sleeves. The insulating casings 336 may have a cylindrical shape.

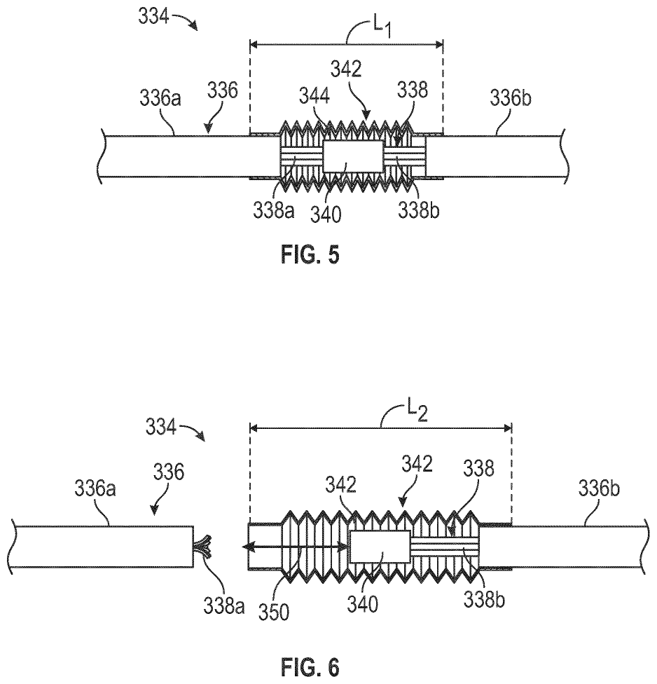

As shown in FIGS. 5 and 6, the insulating casing 336 includes a first insulator portion, shown as first casing portion 336a, and a second inuslator portion, shown as second casing portion 336b, separated or spaced from the first casing portion 336a such that a portion of the wire conductor 338 is not covered by the insulating casing 336. The wire conductor 338 includes a first portion, shown as first conductor portion 338a, at least partially encapsulated or surrounded by the first casing portion 336a and a second portion, shown as second conductor portion 338b, at least partially encapsulated or surrounded by the second casing portion 336b and connected to the first conductor portion 338a at separation or breakaway point, shown as breakaway joint 340.

According to an exemplary embodiment, the breakaway joint 340 is configured to provide a controlled point of weakness along the wire conductor 338 to permit controlled separation of the wire conductor 338. By way of example, the breakaway joint 340 may be configured to withstand normal operating conditions and use of the battery charger system 300 and may be being configured (e.g., engineered, designed, calibrated, etc.) to separate or sever under a predetermined strain and/or tensile force (e.g., tensile load) being applied to the power cable 330 and the charging plug 310 (e.g., the vehicle 10 being driven away with the charging plug 310 engaged with the charging port 51, the power cable 330 being pulled on by an external force such as being caught on a moving object or being tripped over, etc.). According to an exemplary embodiment, the breakaway joint 340 has a lower tensile strength than the first conductor portion 338a and the second conductor portion 338b proximate the breakaway joint 340 such that the breakaway joint 340 fails prior to the first conductor portion 338a and the second conductor portion 338b.

In some embodiments, the breakaway joint 340 includes an electrical splice connector having a first end crimped to the first conductor portion 338a and an opposing second end crimped to the second conductor portion 338b. In such embodiments, the electrical spline connector may be crimped to one of the first conductor portion 338a or the second conductor portion 338b with a greater clamp or crimp force that the other one of the first conductor portion 338a or the second conductor portion 338b. Similarly, the clamp or crimp force applied to the first and second ends of the electrical splice connector can be varied to modulate the breakaway force required to break the breakaway joint 340. In some embodiments, the breakaway joint 340 includes a reduced diameter (e.g., deformed, compressed, crimped, etc.) portion of the wire conductor 338 that has greater rigidity and less tensile strength than the remainder of the wire conductor 338 such that the breakaway joint 340 fails prior to the other portions of the wire conductor 338. In some embodiments, the breakaway joint 340 includes a solder joint connecting the first conductor portion 338a and the second conductor portion 338b together where the solder joint has less tensile strength than the remainder of the wire conductor 338 such that the breakaway joint 340 fails prior to the other portions of the wire conductor 338.

The breakaway joint 340 may be calibrated by selecting materials that determine the tensile strength at which failure of the breakaway joint 340 occurs. The breakaway joint 340 may be calibrated by conducting mechanical tests, such as tensile testing, to determine the force required for failure. The breakaway joint 340 may be calibrated by adjusting the crimping process and/or varying the compression applied during crimping to control the tensile strength and the corresponding tensile force required for failure.

As shown in FIGS. 5 and 6, the portion of the wire conductor 338 not covered by the insulating casing 336 is covered or surrounded by the insulator 342. More specifically, the insulator 342 extends between the first casing portion 336a and the second casing portion 336b, and surrounds the breakaway joint 340 both prior to failure (as shown in FIG. 5) and after failure (e.g., as shown in FIG. 6). According to the exemplary embodiment shown in FIGS. 5 and 6, the insulator 342 has an accordion structure including a plurality of ridges or bellows, shown as bellows 344, that facilitate compressing and expanding the insulator 342 between a first or compressed length L1 and a second or expanded length L2. In other embodiments, the insulator 342 does not includes the bellows 344. Rather, the insulator 342 may have a length that extends a certain amount along each of the first casing portion 336a and the second casing portion 336b.

According to exemplary embodiment, a first end of the insulator 342 is coupled (e.g., with adhesive, with a fastener or clamp, ultrasonically welded, etc.) to the second casing portion 336b and compressed between the first casing portion 336a and the second casing portion 336b. According to an embodiment, the opposing second end of the insulator 342 is more loosely coupled to the first casing portion 336a (e.g., via a compression fit, a snap fit, etc.) than the first end of the insulator 342 to the second casing portion 336b. Accordingly, the insulator 342 has a strong mechanical bond to the second casing portion 336b than the first casing portion 336a that prevents detachment of the insulator 342 from the second casing portion 336b but permits detachment of the insulator 342 from the first casing portion 336a under failure conditions. In embodiments, where the insulator 342 includes the bellows 344, the insulator 342 is configured to expand during such a failure event.

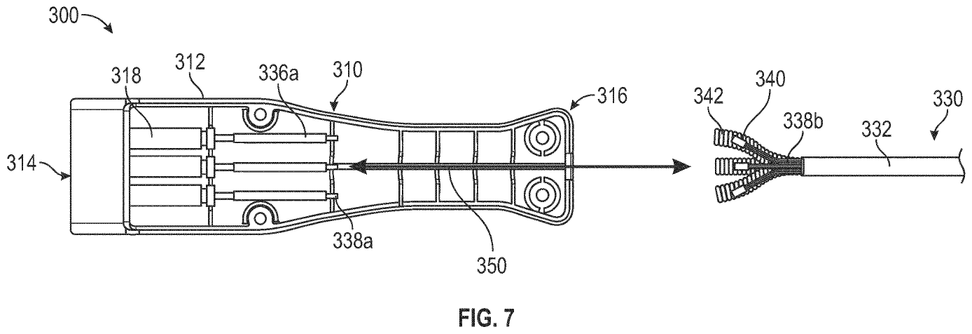

As shown in FIGS. 6 and 7, power cable 330 is subjected to an external force, shown as pulling force 350, such as during entanglement or accidental yanking, the resultant force at the breakaway joint 340 increases. When the pulling force 350 exceeds a predetermined threshold, the breakaway joint 340 fails (e.g., separates, undergoes a process known as “necking” where the wire conductor 338 begins to thin where stresses concentrate until fracture). Failure occurs at the breakaway joint 340 rather than anywhere else along the wire conductor 338. When the pulling force 350 exceeds the yield strength of the breakaway joint 340 material, the breakaway joint 340 is configured to undergo a clean break or separation. The breakaway joint 340 is configured to detach the first conductor portion 338a and the second conductor portion 338b at the breakaway joint 340. Accordingly, the second conductor portions 338b remain live and remain connected to the charging station 320, while the first conductor portions 338a become disconnected (e.g., detached) from the charging station 320 and don't carry electrical current.

As shown in FIGS. 6 and 7, upon failure, the insulator 342 is configured to detach from the first casing portion 336a while remaining firmly attached or anchored to the second casing portion 336b. In embodiments where the insulator 342 includes the bellows 344, the bellows 344 are configured to expand from the previously compressed state with the compressed length L1 (as shown in FIG. 5) to an expanded state with the expanded length L2 (as shown in FIG. 6) to sufficiently extend beyond the breakaway joint 340 and the second conductor portion 338b to provide a protective barrier against accidental contact and electrical shock with live electrical wires. By surrounding the breakaway joint 340, the insulators 342 are configured to cover the second conductor portions 338b and the breakaway joints 340 when failure occurs. In some embodiments (e.g., where the breakaway joint 340 includes an electrical splice connector), the breakaway joint 340 is configured to fail and remain attached with second conductor portion 338b. In other embodiments, the breakaway joint 340 is configured to fail and remain attached to the first conductor portion 338a. Regardless, the live end of the power cable 330 remains covered by the insulators 306 thereby reducing the likelihood of electrical shock during failure of the power cable 330.

The pulling force 350 can arise from several factors that may occur during the operation of the battery charger system 300. For example, the pulling force 350 may occur when the charging plug 310 is inadvertently shifted due to user interaction. In an example, when the charging plug 310 has been disconnected from a vehicle 10 after charging, and then left hanging or suspended, the charging plug 310 can be caught or snagged by the vehicle 10 as it is being driven past or away from the charging station 320.

For instance, if the vehicle 10 is repositioned while charging, the movement can generate pulling force 350 (e.g., tension) in the charging cable, leading to strain at the breakaway joint 340. As another example, the pulling force 350 may result from accidental yanking when users inadvertently tug on the power cable 330 (e.g., when in a hurry or distracted).

As shown in FIGS. 8 and 10, the power cable 330 does not includes the insulators 342. Rather, as shown in FIGS. 8 and 9, the insulating casings 336 form a single, continuous casing around the wire conductors 338 and the charging plug 310 includes a separation structure, shown as divider plate 360, disposed within the plug housing 312. The divider plate 360 may provide support, organization, and stability for the wires 334. As shown in FIG. 9, the divider plate 360 defines a plurality of passages or slots, shown as retention slots 362. The retention slots 362 are grooves and/or channels that are configured to accommodate the wires 334. The number of retention slots 362 corresponds with the number of wires 334 of the power cable 330 (e.g., three retention slots 362 when the power cable 330 includes three wires 334). As shown in FIG. 8, the breakaway joints 340 of the wires 334 are positioned closer to the cable end 316 of the plug housing 312 than the divider plate 360.

According to an exemplary embodiment, the retention slots 362 include or have angled, knife-like edges positioned along the inner edges thereof. The angled edges grip the insulating casings 336 and ensure that the wires 334 remain securely in place during normal operation. The retention slots 362 are configured to guide the wires 334 through a predetermined path. The retention slots 362 and the angled, edges can be constructed from high-strength materials that withstand repeated stress and wear, such as plastics or reinforced plastic. In some embodiments, the retention slots 362 include a metal component such as a razor blade along the angled edges.

As shown in FIG. 10, the battery charger system 300 is in a failed state where the power cable 330 is experiencing the pulling force 350 such that the power cable 330 separates from the charging plug 310. The wire conductors 338 are configured to break (e.g., rip) at the breakaway joint 340 into two portions (i.e., the first conductor portion 338a and the second conductor portion 338b) when the pulling force 350 exceeds the predetermined threshold.

According to an exemplary embodiment, the angled, knife-like edges of the retention slots 362 are configured to engage with the insulating casings 336 and cut, rip, or sever the insulating casings 336 into two pieces (i.e., the first casing portion 336a and the second casing portion 336b) at a position closer to the plug end 314 than the breakaway joints 340 when that the pulling force 350 exceeds a predetermined threshold. The angled, knife-like edges of the retention slots 362 are configured to cut the insulating casing 336 such that the second casing portion 336b extends beyond the end of the second conductor portion 338b and the breakaway joint 340. Accordingly, the second conductor portions 338b of the wire conductors 338 can be insulated beyond the tip ends thereof if the power cable 330 is pulled from the plug housing 312. In some embodiments, the insulators 342 and the divider plate 360 are used in combination.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A power cord assembly comprising:
a charging plug including:
a housing having a plug end configured to interface with a charging port of an electric vehicle and a cord end; and
a charging interface position at the plug end of the housing;
a power cord extending through the cord end of the housing and coupled to the charging interface, the power cord including a plurality of wires, each of the plurality of wires including:
a conductor having a breakaway joint along a length thereof between a first portion of the conductor and a second portion of the conductor, the first portion connected to a power source and the second portion connected to the charging interface; and
one or more insulators disposed along the length of the conductor;
wherein upon failure of the conductor at the breakaway joint, the one or more insulators are configured to separate such that a free end of the first portion of the conductor is covered.

2. The power cord assembly of claim 1, wherein the one or more insulators include a first insulator disposed along a portion of the first portion, a second insulator disposed along a portion of the second portion such that a gap is present between the first insulator and the second insulator, and a third insulator extending between the first insulator and the second insulator across the gap and around the breakaway joint.

3. The power cord assembly of claim 2, wherein upon failure of the conductor at the breakaway joint, the third insulator is configured to detach from the second insulator and remain attached to the first insulator.

4. The power cord assembly of claim 2, wherein the third insulator has a bellows shape or an accordion shape.

5. The power cord assembly of claim 4, wherein the third insulator is compressed between the first insulator and the second insulator.

6. The power cord assembly of claim 5, wherein the third insulator is configured to expand upon failure of the breakaway joint and separation of the first portion and the second portion of the conductor.

7. The power cord assembly of claim 1, wherein the breakaway joint has a lower tensile strength than the first portion of the conductor and the second portion of the conductor.

8. The power cord assembly of claim 1, wherein the breakaway joint comprises a crimp or a reduction in the cross-sectional area of the conductor.

9. The power cord assembly of claim 1, wherein the breakaway joint includes an electrical splice connector having a first end crimped to the first portion and an opposing second end crimped to the second portion.

10. The power cord assembly of claim 1, wherein the breakaway joint includes a soldered joint connecting the first portion and the second portion.

11. The power cord assembly of claim 1, wherein the charging plug includes a divider disposed within the housing, the divider defining a plurality of slots, each of the plurality of slots receiving one of the plurality of wires.

12. The power cord assembly of claim 11, wherein the breakaway joint is positioned between the divider and the plug end of the housing.

13. The power cord assembly of claim 12, wherein each of the plurality of slots has an angled edge, wherein, upon failure of the breakaway joint, the angled edge is configured to sever the insulator into a first insulator portion around the first portion of the conductor and a second insulator portion around the second portion of the conductor, and wherein the first insulator portion extends past the free end of the first portion of the conductor.

14. A power cord assembly comprising:
a power cord configured to extend into a charging plug and couple to a charging interface thereof, the power cord including a plurality of wires, each of the plurality of wires including:
a conductor having a breakaway joint along a length thereof between a first portion of the conductor and a second portion of the conductor, the first portion configured to connect to a power source and the second portion configured to connect to the charging interface; and
one or more insulators disposed along the length of the conductor;
wherein upon failure of the conductor at the breakaway joint, the one or more insulators are configured to separate such that a free end of the first portion of the conductor is covered.

15. The power cord assembly of claim 14, wherein the one or more insulators include a first insulator disposed along a portion of the first portion, a second insulator disposed along a portion of the second portion such that a gap is present between the first insulator and the second insulator, and a third insulator extending between the first insulator and the second insulator across the gap and around the breakaway joint.

16. The power cord assembly of claim 15, wherein upon failure of the conductor at the breakaway joint, the third insulator is configured to detach from the second insulator and remain attached to the first insulator.

17. The power cord assembly of claim 16, wherein the third insulator is compressed between the first insulator and the second insulator, and wherein the third insulator is configured to expand upon failure of the breakaway joint and separation of the first portion and the second portion of the conductor.

18. The power cord assembly of claim 1, further comprising a divider configured to be disposed within the charging plug, the divider defining a plurality of slots, each of the plurality of slots receiving one of the plurality of wires, wherein the breakaway joint is positioned between the divider and the plug end of the housing, wherein each of the plurality of slots has an angled edge, wherein, upon failure of the breakaway joint, the angled edge is configured to sever the insulator into a first insulator portion around the first portion of the conductor and a second insulator portion around the second portion of the conductor, and wherein the first insulator portion extends past the free end of the first portion of the conductor.

19. A power cord assembly comprising:
a charging plug including:
a housing having a plug end configured to interface with a charging port of an electric vehicle and a cord end; and
a charging interface position at the plug end of the housing;
a power cord extending through the cord end of the housing and coupled to the charging interface, the power cord including a plurality of wires, each of the plurality of wires including:
a conductor having a breakaway joint along a length thereof between a first portion of the conductor and a second portion of the conductor, the first portion connected to a power source and the second portion connected to the charging interface;
a first insulator disposed along a portion of the first portion;
a second insulator disposed along a portion of the second portion such that a gap is present between the first insulator and the second insulator; and
a third insulator extending between the first insulator and the second insulator across the gap and around the breakaway joint
wherein upon failure of the conductor at the breakaway joint, the first insulator and the third insulator are configured to separate from the second insulator such that a free end of the first portion of the conductor is covered.

20. The power cord assembly of claim 19, wherein the third insulator is compressed between the first insulator and the second insulator, and wherein the third insulator is configured to expand upon failure of the breakaway joint and separation of the first portion and the second portion of the conductor.
